(19) United States
(12) Patent Application Publication
(10) Pub. No.: US 2004/0027654 A1
(43) Pub. Date: Feb. 12, 2004

(54) Microscope

(76) Inventor: Matthias Gonschor, Gleichen (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/257,422

(22) PCT Filed: Nov. 28, 2001
(86) PCT No.: PCT/EP01/13875

(30) Foreign Application Priority Data
Dec. 1, 2000 (DE) 100 60 456.0

(51) Int. Cl. G02B 21/00

(52) U.S. Cl. 359/368

(57) ABSTRACT

A microscope having a plurality of electrically controlled microscope components such as objective nosepieces, filter turrets, diaphragms, light-path switching devices, illumination devices, and so on, which influence the light path in the microscope is disclosed. In order to be able to operate the operator controls for these components in a reliable manner even in unfavorable ambient light conditions, switchable illumination is provided for these operator controls.

### CROSS-REFERENCE TO RELATED APPLICATIONS

This application claims priority of International Application No. PCT/EP01/13875, filed Nov. 28, 2001 and German Application No. 100 60 456.0, filed Dec. 1, 2000, the complete disclosures of which are hereby incorporated by reference.

### BACKGROUND OF THE INVENTION

a) Field of the Invention

The invention is directed to a microscope which can be outfitted with a plurality of components such as objective nosepieces, diverse filters and diaphragms, controllable illumination devices, and so on.

In modern microscopes, these components can often be operated electrically or manually. Normally, therefore, for operation, these microscopes have a corresponding number of operator controls (switches, buttons, turning knobs, levers, adjusting wheels) which are arranged as ergonomically as possible. These operator controls can be accommodated at the microscope stand as well as on separate control panels.

b) Description of the Related Art

These operator controls often have script or scales which indicate the status of the associated microscope components, e.g., for the different filter sets in the reflector turret or the position of the focus drive mechanism (z-position). It is frequently the case that microscopic preparations are examined in dark or extensively darkened surroundings in order to eliminate or minimize the influence of extraneous light on the microscope imaging. This is true particularly when observing weak fluorescence or luminescence. The dark environment makes it difficult for the user of the microscope to operate the device, since the operator controls can no longer be seen or read.

It is known (e.g., control panel for the “Axiotron 2” microscope of the present Applicant, brochure 40-405 e/05.00) to arrange LEDs (light-emitting diodes) on the buttons of the control panel in order in order to show the current switching state of the operator controls. However, these LEDs do not help for purposes of orientation because they are only activated when the corresponding button is actuated.

### OBJECT AND SUMMARY OF THE INVENTION

Therefore, it is the primary object of the invention to overcome the disadvantages of the prior art and to simplify the operation of electrically controllable or motor-driven and manually operated microscopes.

This object is met in a microscope with a microscope stand which contains electrically controllable microscope components such as objective nosepieces, diaphragms, filters, condensers, light-path switches for clearing a fluorescence path, and in which operator controls are provided for these microscope components, comprising that at least one device is provided for illuminating these operator controls.

It is advantageous when the illumination of the operator controls can be switched between two brightness settings by means of a switch. In this way, the operator control illumination can be switched off and its brightness can also be noticeably reduced.

In an advantageous embodiment form according to the invention, the illumination of the operator controls is switched automatically depending on the unobstructed beam path in the microscope, e.g., the operator control illumination is reduced when the fluorescence beam path is clear, so that no troublesome light from the illumination can fall on the specimen being examined.

It is advantageous when the illumination devices are arranged and directed in such a way that the script or scales of the operator controls are so illuminated that the user of the microscope can read them from his normal position.

In principle, any lighting means such as miniature incandescent bulbs, LEDs (light-emitting diodes) or the like can be used for illumination. However, the light can also be guided to the location to be illuminated by means of light-conducting fibers.

A further advantageous construction of the invention consists in that the operator controls themselves have illumination devices and are therefore constructed as a self-illuminating buttons or knobs.

Another advantageous embodiment form of the invention preferably has a sensor in the vicinity of the eyepieces, which sensor detects the approach of the user's head toward the eyepieces and is coupled with the operator control illumination in such a way that the latter is switched off or its brightness is reduced as long as the user looks through the eyepieces.

### BRIEF DESCRIPTION OF THE DRAWING

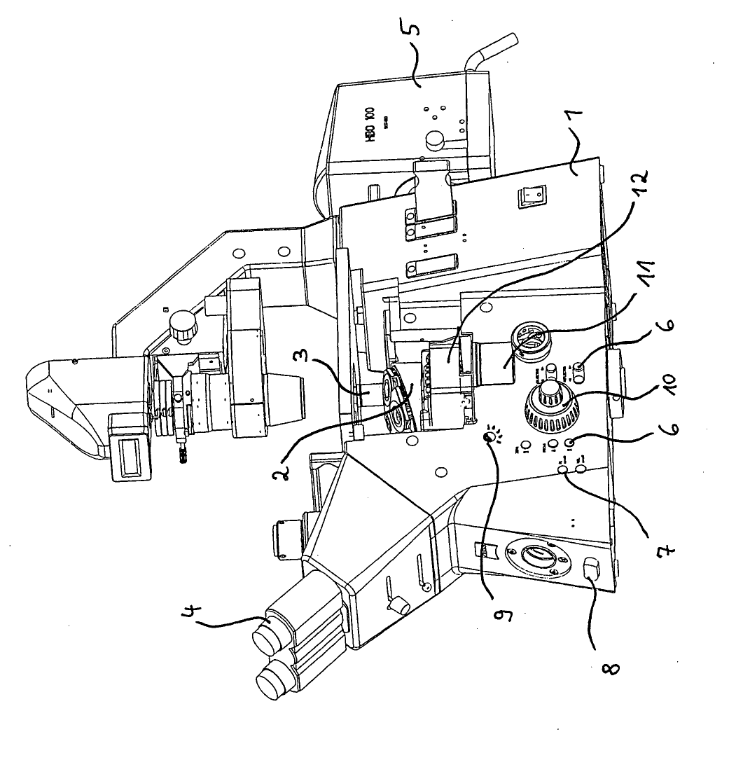

The drawing, FIG. 1, shows a schematic view of an embodiment example of a microscope according to the invention using the example of an inverted microscope.

### DESCRIPTION OF THE PREFERRED EMBODIMENTS

A motor-driven objective nosepiece 2 with (in this case, only one) objective 3, eyepieces 4, a motor-driven reflector turret 12 and a controllable object illumination device 5 for fluorescence excitation are arranged at the microscope stand 1. A shutter, not shown, is located inside the stand in the fluorescence beam path for blocking and clearing the beam path and is controlled by an operator control 7. Further, the stand 1 has a focus drive knob 10 and a quantity of control buttons 6 which are arranged in an ergonomic manner in the vicinity of the focus drive knob 10. The focus drive 11 is motor-actuated by the focus drive knob 10 via control computers (not shown) which are installed in the microscope stand 1. The focus drive knob has a scale by means of which the focusing position can be read.

An illumination device 9 is arranged at the side of the stand 1 in the vicinity of the operator controls 6 and focus drive knob 10. This illumination device 9 is constructed, e.g., as a light-emitting diode (LED), but can also be another illumination device, e.g., a miniature incandescent bulb. This illumination device is so placed and directed that it illuminates the operator controls when switched on such that the user of the microscope can easily perceive the script on the operator controls without being forced to remove his head far from the normal viewing position (at the eyepieces). When actuated, a determined operator control 8 causes the illumination of the operator control to be switched on or switched off. A button or a switch can be used as operator control 8, for example. This operator control 8 can also be constructed in such a way that it has a third switching position in which the illumination of the operator controls can be switched on and switched off so as to be coupled with the switching state of the operator control 7 associated with the shutter for the fluorescence beam path. This coupling is carried out in such a way that the operator control illumination is switched off when the fluorescence beam path is clear. This ensures that no troublesome light from the operator control illumination can fall on the specimen while observing.

The invention is not limited to the embodiment example shown herein. Several illumination devices can also be provided for the various operator controls of the microscope. When light-conducting fibers are used for the illumination of the operator controls, it is also possible for light from one of the light sources provided for illuminating the specimen to be coupled into the light-conducting fibers, e.g., the light falls on the in-coupling location of the light-conducting fibers when the shutter for the fluorescence beam path is closed, but is blocked off from the light-conducting fibers when the shutter is open.

It is likewise possible to implement the illumination of the operator controls by illuminating means arranged at or in the operator controls in that, e.g., LEDs are integrated in the switches and/or buttons.

The control of the operator control illumination can also be coupled with a sensor which is arranged in the vicinity of the eyepieces, which can detect the approach of the user of the microscope toward the eyepieces when using the microscope, and which switches off or reduces the operator control illumination. A sensor of this type is known, per se, from JP1011146A2, for example. Further, the invention can be used in upright microscopes or in inverted and motor-driven microscopes as well as in manual microscopes.

While the foregoing description and drawings represent the present invention, it will be obvious to those skilled in the art that various changes may be made therein without departing from the true spirit and scope of the present invention.

1. Microscope with a microscope stand which preferably contains electrically controllable microscope components such as objective nosepieces, diaphragms, filters, condensers, light-path switches (e.g., to clear a fluorescence beam path), and so on, and in which operator controls are provided for these microscope components, characterized in that at least one device is provided for illuminating these operator controls.

2. Microscope according to claim 1, characterized in that an operator control is provided which switches this illumination between two different brightness settings.

3. Microscope according to claim 2, characterized in that the operator control is a button.

4. Microscope according to claim 2, characterized in that the operator control is a switch, preferably having three switching positions.

5. Microscope according to claim 1, characterized in that means are provided which switch this illumination depending on the position of at least one of these microscope components.

6. Microscope according to claim 5, characterized in that the device for illuminating the operator controls is preferably electrically coupled with the operator control for controlling the microscope components.

7. Microscope according to claim 5, characterized in that the illumination of the operator controls is reduced when the operator control for controlling the clearing of the fluorescence beam path is actuated.

8. Microscope according to claim 1, characterized in that the device for illuminating the operator controls is directed and/or arranged at the microscope stand in such a way that script on the operator controls can be seen from the normal position of the user of the microscope.

9. Microscope according to claim 1 or 8, characterized in that the device for illuminating the operator controls is arranged approximately in an imaginary connecting line between the eyepieces of the microscope and the operator controls of the microscope components and preferably radiates in the viewing direction of a user of the microscope toward the operator controls.

10. Microscope, preferably according to one of the preceding claims, characterized in that the operator control for switching the illumination of the operator controls has switching positions for switching on illumination, switching off or reducing illumination, switching illumination depending on the position of at least one of the microscope components.

11. Microscope according to claim 1, characterized in that the device for illuminating the operator controls has illuminating means, e.g., a light-emitting diode or a miniature incandescent bulb.

12. Microscope according to claim 1, characterized in that the device for illuminating the operator controls has at least one light-conducting fiber into which light can be coupled by illuminating means.

13. Microscope according to claim 1, characterized in that the device for illuminating the operator controls is integrated in the operator controls.

14. Microscope according to claim 1, characterized in that a sensor is arranged preferably in the vicinity of the eyepieces which responds to the approach of the user of the microscope and which is coupled with the device for illuminating the microscope in such a way that it reduces or switches off the illumination of the operator controls at the approach of the user.
